(19) United States
(12) Patent Application Publication
(10) Pub. No.: US 2008/0267489 A1
(43) Pub. Date: Oct. 30, 2008

(54) METHOD FOR DETERMINING ABNORMAL CHARACTERISTICS IN INTEGRATED CIRCUIT MANUFACTURING PROCESS

(75) Inventors: Hong Xiao, Pleasanton, CA (US); Jack Jau, Los Altos Hills, CA (US)

Correspondence Address: SAWYER LAW GROUP LLP, 2465 E. Bayshore Road, Suite No. 406, PALO ALTO, CA, 94303, US

(73) Assignee: Hermes- Microvision, Inc., Hsinchu (TW)

(21) Appl. No.: 12/109,243

(22) Filed: Apr. 24, 2008

Related U.S. Application Data
(60) Provisional application No. 60/913,701, filed on Apr. 24, 2007.

(51) Int. Cl. G06K 9/00

(52) U.S. Cl. 382/147

(57) ABSTRACT

A method for determining abnormal characteristics in integrated circuit manufacturing process is disclosed. The method comprises obtaining a charged particle microscope image of a sample test structure, wherein the sample including a reference pattern and a test pattern; measuring gray levels of the reference pattern and the test pattern; calculating a standard deviation from a distribution of the gray levels of the reference pattern measured; and determining the abnormal characteristics of the test pattern based on the gray levels measured and the standard deviation.

### CROSS-REFERENCE TO RELATED APPLICATION

This Application is the U.S. Non-Provisional patent application of U.S. Provisional Patent Application No. 60/913,701 filed on Apr. 24, 2007 entitled, “Test Structures for IC Manufacturing Process Monitoring Using Charged Particle Beam System” the priority of which is hereby claimed, and the entirety of which is incorporated herein by this reference.

### FIELD OF THE INVENTION

The present invention relates generally to an integrated circuit manufacturing process using a particle beam system, in particular to a method for determining abnormal characteristics in an integrated circuit manufacturing process.

### BACKGROUND OF THE INVENTION

Charged particle beam systems such as electron beam inspection (EBI) systems are increasingly utilized in advanced integrated circuit chip manufacturing. The systems have high resolution that can be used to detect tiny physical defects that beyond the capability of optical defect inspection systems. Another advantage of the EBI system is that it can detect voltage contrast (VC) defects of electrical circuitry such as open circuit, short circuit or leakage underneath the wafer surface because of surface charge induced gray level (GL) variation. However, there is still a need to find out the level of leakage as to determine how severe the defect is.

### SUMMARY OF THE INVENTION

In summary, the defective microelectronics devices can be created in a test structure to monitor integrated circuit manufacturing process with a charged particle beam system. The gray level of the defective microelectronics devices in the test structure can be used as a reference to determine the degree of the defect of the normal microelectronics devices having the defective issue, such as leakage or short.

A method for determining abnormal characteristics in integrated circuit manufacturing process is disclosed. The method comprises the steps of obtaining a charged particle microscope image of a sample test structure, wherein the sample including a reference pattern and a test pattern; measuring gray levels of the reference pattern and the test pattern; calculating a standard deviation from a distribution of the gray levels of the reference pattern measured; and determining the abnormal characteristics of the test pattern based on the gray levels measured and the standard deviation. The step of determining the abnormal characteristics further comprises the steps of calculating an average gray level from the gray levels of the reference pattern measured; calculating a factor based on the average gray level, the gray level of the test pattern and the standard deviation; predetermining at least one characteristic value; and comparing the factor to the characteristic value as to determine the abnormal characteristics

### BRIEF DESCRIPTION OF THE DRAWINGS

FIG. 1 is a schematic drawing of an electron beam defect inspection system in accordance with an embodiment.

FIG. 1A is a cross-sectional view of a normal PMOS device.

FIG. 1B is a cross-sectional view of a normal NMOS device.

FIG. 2A is a cross-sectional view of a normal PMOS device, same as FIG. 1A.

FIG. 2B is a cross-sectional view of a PMOS device with S/D-to-substrate short.

FIG. 3A is a cross-sectional view of a normal NMOS device, same as FIG. 1B.

FIG. 3B is a cross-sectional view of a NMOS device with S/D-to-well short.

FIG. 4A is a cross-sectional view of a normal PMOS device, same as FIG. 1A.

FIG. 4B is a cross-sectional view of a PMOS device with S-D short.

FIG. 5A is a cross-sectional view of a normal NMOS device, same as FIG. 1B.

FIG. 5B is a cross-sectional view of a NMOS device with S-D short.

FIG. 6A is a cross-sectional view of a normal PMOS device, same as FIG. 1A.

FIG. 6B is a cross-sectional view of a PMOS device with S/D-to-well leakage.

FIG. 7A is a cross-sectional view of a normal NMOS device, same as FIG. 1B.

FIG. 7B is a cross-sectional view of a NMOS device with S/D-to-well leakage.

FIG. 8 illustrates a layout of arrays of integrated circuit devices.

FIG. 9 illustrates a SEM image of FIG. 8 after silicide formation.

FIG. 10 illustrates the cumulative probability curves of N+/P-well GL and P+/P-well GL.

FIG. 11 illustrates a histogram of the gray level of the SEM image illustrated in FIG. 9.

FIG. 12 illustrates an image of the test pattern with a bright voltage contrast (BVC) defect.

FIG. 13 illustrates the expected positive mode SEM image of EBI after tungsten chemical mechanical polish (WCMP) of the test structure illustrated in FIG. 8.

FIG. 14 illustrates a histogram of the gray level of the image illustrated in FIG. 13.

FIG. 15 illustrates an image of the test pattern with a BVC defect.

FIG. 16 is a layout of arrays of integrated circuit devices having both the N+/P-well and P+/N-well placed along with the reference pattern of P+/P-well.

FIG. 17 is a flowchart showing a method for determining abnormal characteristics in integrated circuit manufacturing process.

FIG. 18A illustrates a SEM image of a normal SRAM.

FIG. 18B illustrates a SEM image of a SRAM with N+/P-well leakage.

### DETAILED DESCRIPTION OF THE EXEMPLARY EMBODIMENTS

Reference will now be made in detail to specific embodiments of the invention. Examples of these embodiments are illustrated in accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well known process operations are not been described in detail in order not to unnecessarily obscure the present invention.

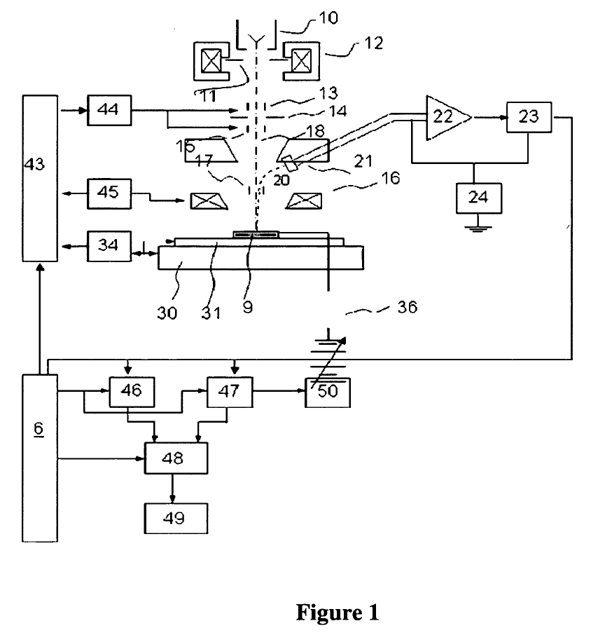

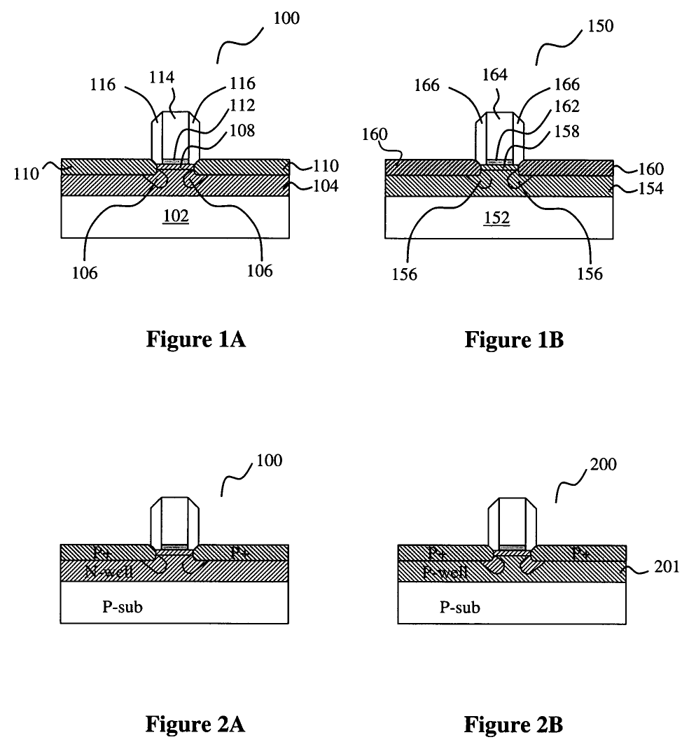

A charge particle beam system may be, for example, an electron beam system. FIG. 1 is a schematic drawing of an electron beam defect inspection system in accordance with an embodiment. The system includes several portions, namely, a primary electron beam source, a secondary electron detection portion, an image processing portion, and a system control portion. The primary electron beam source portion includes electron gun 10, beam extraction electrode 11, condenser lens 12, beam blanking deflector 13, aperture 14, scanning deflector 15, and objective lens 16. The secondary electron detection portion includes an E×B electron detour device 17, secondary electron detector 21, preamplifier 22, A/D converter 23, and high voltage electric source 24. The image processing portion includes the first image storage 46, the second image storage 47, arithmetic operation device 48, defect judgment device 49, and monitor 50. The system control portion includes microprocessor computer 6, position correction and control circuit 43, stage driver 34, objective lens source 45, scan deflector signal generator 44, sample stage 30, X-Y direction stage 31, and high voltage electric source 36. The inspection process is proceeding as the inspection object 9 (wafer) sitting on the sample stage 30 is irradiated by the primary electron beam 19. The secondary electron 20 emanating from the substrate surface 9 is detoured by E×B 17 to the detector 21, the electron signal is then being amplified and converted to digital signal for further image processing and defect judgment. In accordance with a preload recipe firmware, the microprocessor computer 6 guides the stage driver 34 and scan signal generator 44 to properly provide the inspection.

In a system and method in accordance with the present invention integrated circuit devices are designed to leak or short circuit by intentionally doping certain species in ion implantation processes that form wells, channels, source/drain (S/D) and packets. These devices can then be used as a reference pattern for gray level measurement to monitor device leakage in front end of line (FEoL) process control.

FIG. 1A illustrates a cross-section of a normal p-type metal-oxide-semiconductor (PMOS) device 100. The PMOS device 100 comprises a p-type doped substrate 102, a n-type doped well 104, n-type doped pockets 106, a n-type doped channel 108, heavily p-type doped (P+) source and drain (S/D) 110, a very thin layer of gate dielectric 112, a conducting gate electrode 114 and sidewall spacers 116. FIG. 1B illustrates a cross-section of a normal n-type metal-oxide-semiconductor (NMOS) device 150. The NMOS device 150 comprises a p-type doped substrate 152, a p-type doped well 154, p-type doped pockets 156, a p-type doped channel 158, heavily n-type doped (N+) S/D 160, a very thin layer of gate dielectric 162, a conducting gate electrode 164 and sidewall spacers 166.

FIG. 2A illustrates a cross-section of a normal PMOS device 100 again (same as FIG. 1A). FIG. 2B shows a PMOS device 200 with S/D-to-substrate short by intentionally using a well implantation species 201 that causes a short. For example, instead of implantation of a n-type dopant such as phosphorus, a p-type dopants such as boron is implanted.

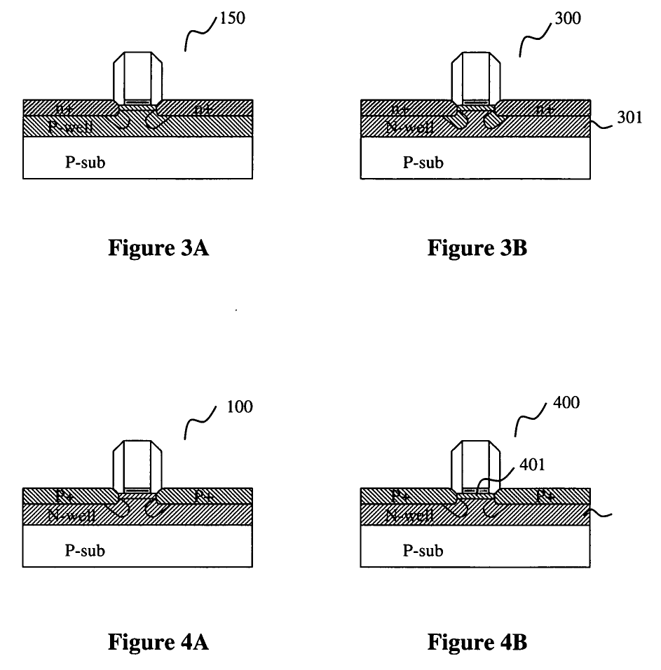

FIG. 3A illustrates a cross-section of a normal NMOS device 150 again (same as FIG. 1B). FIG. 3B shows a NMOS device 300 with S/D-to-well short by intentionally using a well implantation species 301 that causes a short. For example, instead of implantation of a p-type dopant such as boron, a n-type dopants such as phosphorus is implanted.

FIG. 4A illustrates a cross-section of a normal PMOS device 100 again (same as FIG. 1A). FIG. 4B shows a PMOS device 400 with source-to-drain (S-D) short by intentionally using a channel implantation species 401 that causes a short. For example, instead of implantation of a n-type dopant such as phosphorus, a p-type dopants such as boron is implanted.

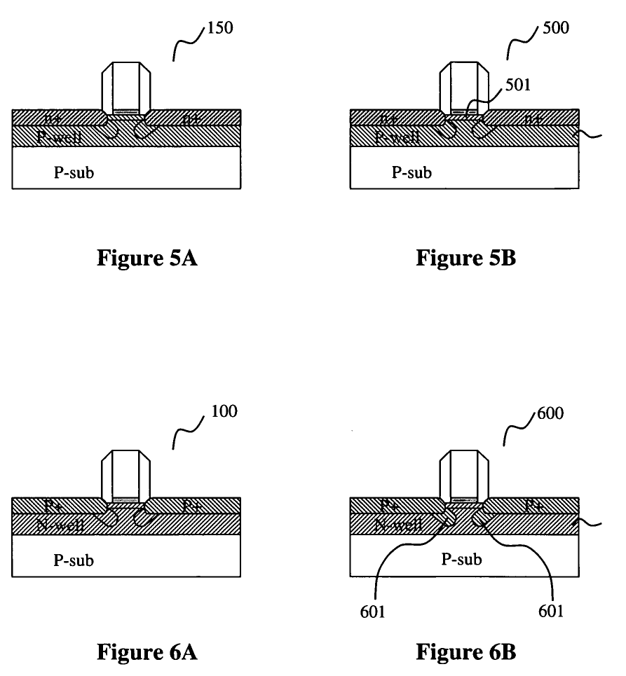

FIG. 5A illustrates a cross-section of a normal NMOS device 150 again (same as FIG. 1B). FIG. 5B shows a NMOS device 500 with S-D short by intentionally using a channel implantation species 501 that causes a short. For example, instead of implantation of a p-type dopant such as boron, a n-type dopants such as phosphorus is implanted.

FIG. 6A illustrates a cross-section of a normal PMOS device 100 again (same as FIG. 1A). FIG. 6B shows a PMOS device 600 with S/D-to-well leakage by intentionally using a packet implantation species 601 that causes leakage. For example, instead of implantation of a n-type dopant such as phosphorus, a p-type dopants such as boron is implanted.

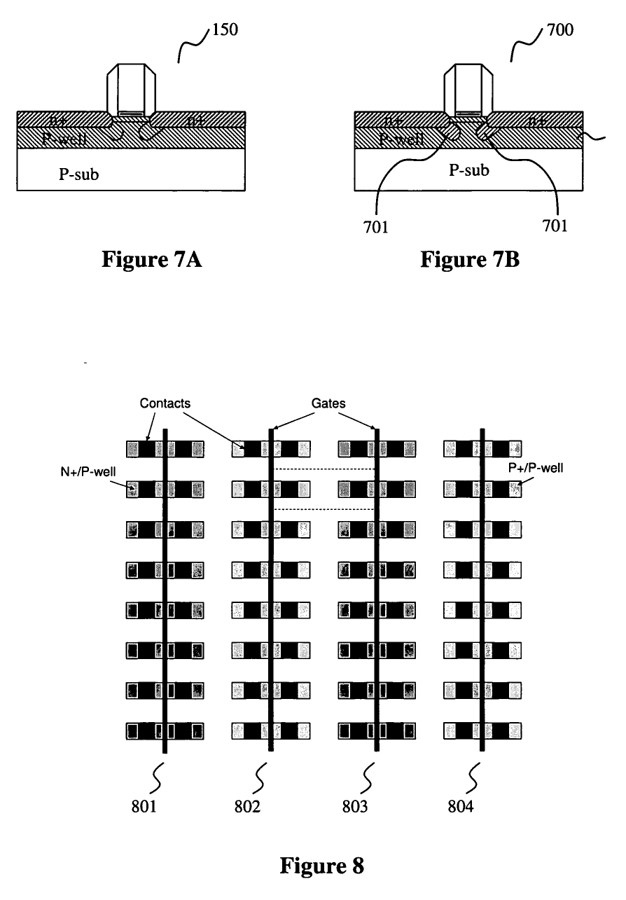

FIG. 7A illustrates a cross-section of a normal NMOS device 150 again (same as FIG. 1B). FIG. 7B shows a NMOS device 700 with S/D-to-well leakage by intentionally using a packet implantation species 701 that causes leakage. For example, instead of implantation of a p-type dopant such as boron, a n-type dopants such as phosphorus is implanted.

FIG. 8 illustrates a layout of two arrays, 801 and 803, of normal NMOS (N+/P-well) devices which forms a test pattern, and two arrays, 802 and 804, of devices with S/D-to-substrate short (P+/P-well) as a reference pattern. The normal NMOS device is also shown in FIG. 1B and the P+/P-well device is same as the PMOS device shown in FIG. 2B. This layout can be put on the scribe line of integrated circuit chip as a test structure and used to monitor NMOS leakage.

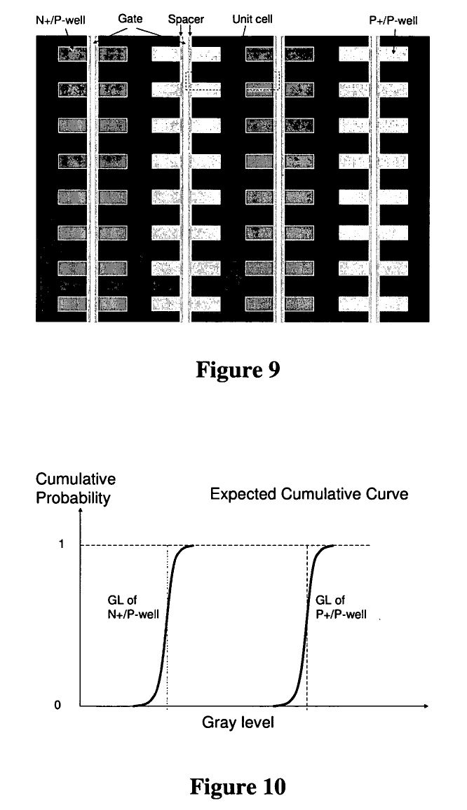

FIG. 9 illustrates an expected positive mode charged particle microscope image, for example a scanning electron microscope (SEM) image, of the test structure illustrated in FIG. 8 after silicide formation. The gray level (GL) of the N+/P-well and P+/N-well can be measured separately using a charged particle beam such as an electron beam (e-beam). The expected cumulative probability curves of N+/P-well GL and P+/P-well GL are shown in FIG. 10.

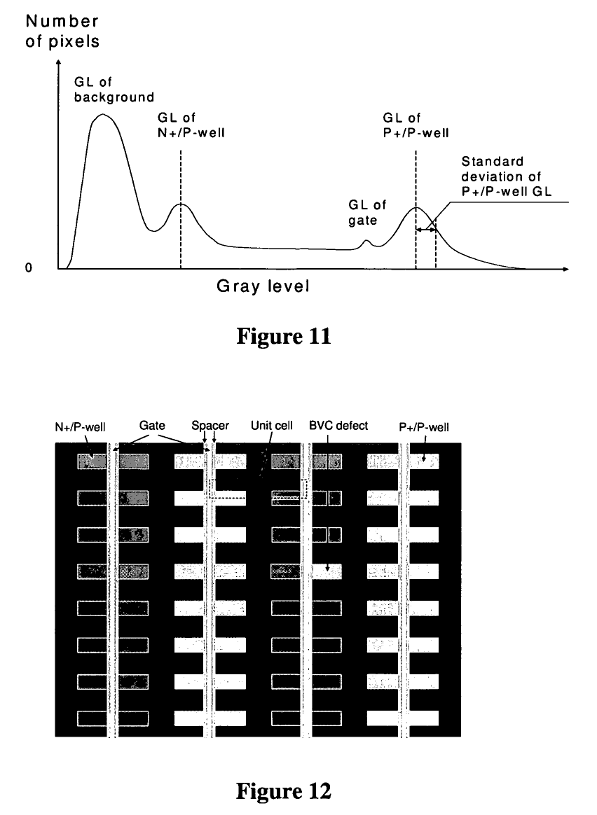

The gray level of N+/P-well can be used to determine whether a leakage occur or the degree of leakage by having the gray level of P+/P-well as a reference level FIG. 11 illustrate a histogram of the gray level of the SEM image illustrated in FIG. 9. The average gray level of P+/P-well (Xg) and its standard deviation (Sg) can be calculated from the histogram. The gray level of N+/P-well (Xnp) of the normal NMOS can also be found from the same histogram. Factor X=(Xg−Xnp)/Sg can be used to determine the abnormal characteristics, such as the leakage characteristics, of the N+/P-well.

X<X0 indicates N+/P-well junction has been shorted to the ground.

X0<X<X1 indicates N+/P-well junction has high leakage to the ground.

X1<X<X2 indicates N+/P-well junction has moderate leakage to the ground.

X2<X<X3 indicates N+/P-well junction has weak leakage to the ground.

X<Xi indicates N+/P-well junction is normal, wherein X0, X1, X2, X3 and Xi are characteristic values that are predetermined by an electrical test that using probes with different voltages to contact different parts of the test structure and measure the leakage current.

The test structure shown in FIG. 8 can also be used to monitor leakage defect using electron beam inspection (EBI) system after silicide formation. FIG. 12 illustrates an image of the test pattern with a bright voltage contrast (BVC) defect. The degree of leakage of the BVC defect can be determined by comparing the gray level of the defect and the gray level of the P+/P-well, which is used as the reference pattern. The average gray level of P+/P-well (Yg) and its standard deviation (Sg) can be calculated from the histogram. The gray level of BVC defect of N+/P-well (Yd) can also be found from the same histogram. Factor Y=(Yg−Yd)/Sg can be used to determine the abnormal characteristics, such as the leakage characteristics, of the defected N+/P-well.

Y<Y0 indicates the defective N+/P-well junction has been shorted to ground.

Y0<Y<Y1 indicates the defective N+/P-well junction has high leakage to the ground.

Y1<Y<Y2 indicates the defective N+/P-well junction has moderate leakage to the ground.

Y2<Y<Y3 indicates the defective N+/P-well junction has weak leakage to the ground.

Y<Yi indicates leakage of the defective N+/P-well junction has no yield impact, wherein Y0, Y1, Y2, Y3 and Yi are characteristic values that are predetermined by an electrical test that using probes with different voltages to contact different parts of the test structure and measure the leakage current.

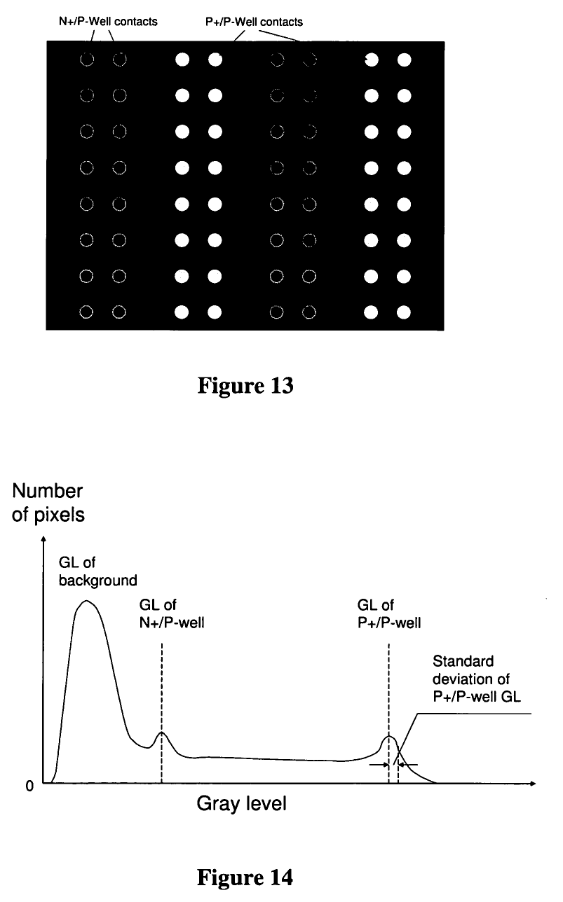

The expected positive mode SEM image of EBI after tungsten chemical mechanical polish (WCMP) of the test structure illustrated in FIG. 8 is shown in FIG. 13. The gray level of the N+/P-well and P+/N-well contacts can be measured separately using a charged particle beam such as an electron beam (e-beam). The expected cumulative probability curves of the gray level of N+/P-well contacts and the gray level of P+/P-well contacts are similar to what is illustrated in FIG. 10.

The gray level of N+/P-well contacts can be used to determine whether N+/P-well junctions are leaked and the degree of leakage by having the gray level of P+/P-well as the reference level. FIG. 14 illustrates an expected histogram of the gray level of the image illustrated in FIG. 13. The average gray level of P+/P-well contact (Wp) and its standard deviation (Sp) can be calculated from the histogram. The gray level of N+/P-well contact (Wn) of the normal NMOS can be found from the same histogram. Factor W=(Wp−Wn)/Sp can be used to determine the abnormal characteristics, such as the leakage characteristics, of the N+/P-well junction.

W<W0 indicates N+/P-well junction has been shorted to ground.

W0<W<W1 indicates N+/P-well junction has high leakage to the ground.

W1<W<W2 indicates N+/P-well junction has moderate leakage to the ground.

W2<W<W3 indicates N+/P-well junction has weak leakage to the ground.

W<Wi indicates N+/P-well junction is normal, wherein W0, W1, W2, W3 and Wi are characteristic values that are predetermined by an electrical test that using probes with different voltages to contact different parts of the test structure and measure the leakage current.

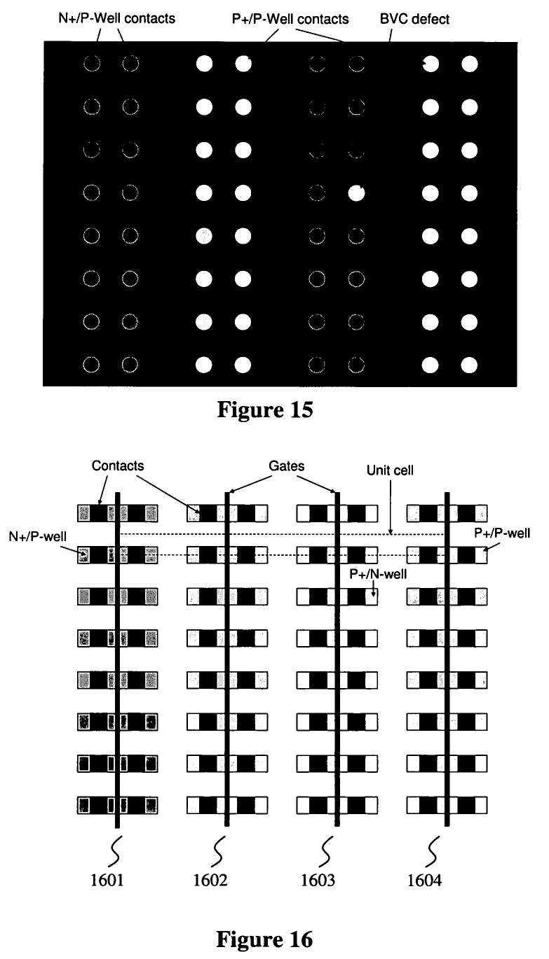

The test structure shown in FIG. 8 can also be used to monitor leakage defect using EBI system after WCMP. FIG. 15 illustrates an image of the test pattern with a BVC defect. The degree of the leakage defect can be determined by comparing the gray level of the BVC defect and the gray level of the P+/P-well, which is used as the reference pattern.

From the histogram of image shown in FIG. 14, the average gray level of P+/P-well (Zp) and its standard deviation (Sp) can be calculated. The gray level of the BVC defect of N+/P-well (Zd) can also be found from the same histogram. Factor Z=(Zg−Zd)/Sg can be used to determine the abnormal characteristics, such as the leakage characteristics, of the defected N+/P-well.

Z<Z0 indicates N+/P-well junction has been shorted to ground.

Z0<Z<Z1 indicates N+/P-well junction has high leakage to the ground.

Z1<Z<Z2 indicates N+/P-well junction has moderate leakage to the ground.

Z2<Z<Z3 indicates N+/P-well junction has weak leakage to the ground.

Z<Zi indicates N+/P-well junction is normal, wherein Z0, Z1, Z2, Z3 and Zi are characteristic values that are predetermined by an electrical test that using probes with different voltages to contact different parts of the test structure and measure the leakage current.

Alternatively, the test pattern of N+/P-well in FIG. 8 can be replaced with the P+/N-well and that test structure can be used to monitoring PMOS leakage. In addition to that, both the N+/P-well and P+/N-well can be placed along with the reference pattern of P+/P-well to form another test structure. FIG. 16 illustrates a test structure having an array of N+/P-well devices 1601, an array of P+/N-well devices 16035 and two arrays of P+/P-well devices 1602, 1604. This test structure can be used to monitor both the NMOS and PMOS leakages or shorts at the same time.

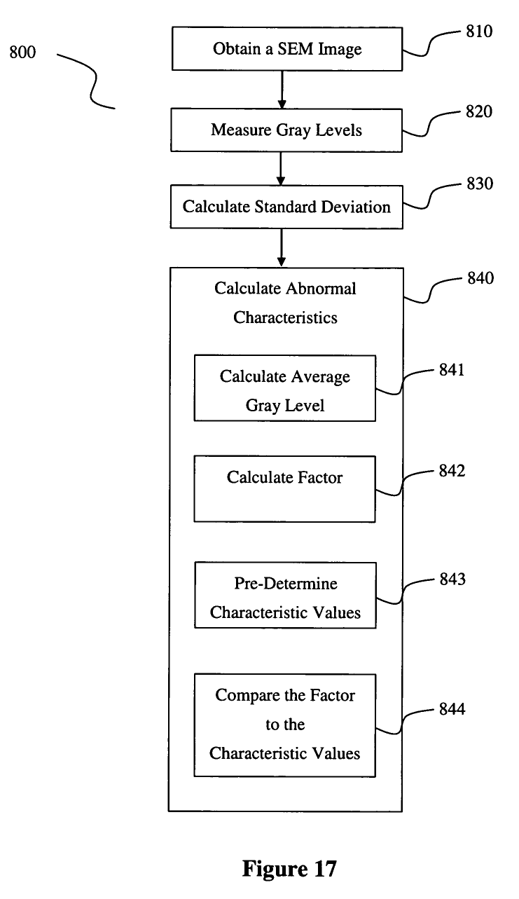

Now referring to FIG. 17, a flowchart 800 showing a method for determining abnormal characteristics in integrated circuit manufacturing process of the present invention. The method comprises the steps of obtaining a charged particle microscope image of a sample test structure, wherein the sample including a reference pattern and a test pattern 810; measuring gray levels of the reference pattern and the test pattern 820; calculating a standard deviation from a distribution of the gray levels of the reference pattern measured 830; and determining the abnormal characteristics of the test pattern based on the gray levels measured and the standard deviation 840. The step of determining the abnormal characteristics 840 further comprises the steps of calculating an average gray level from the gray levels of the reference pattern measured 841; calculating a factor based on the average gray level, the gray level of the test pattern and the standard deviation 842; predetermining at least one characteristic value 843; and comparing the factor to the characteristic value as to determine the abnormal characteristics.

A system that utilizes the firmware to control whole inspection processes in accordance with the present invention can take the form of an entirely hardware implementation, an entirely software implementation, or an implementation containing both hardware and software elements. In one implementation, this disclosure is implemented in firmware in the computer which includes, but is not limited to, application software, firmware, resident software, microcode, etc.

Furthermore, this process can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

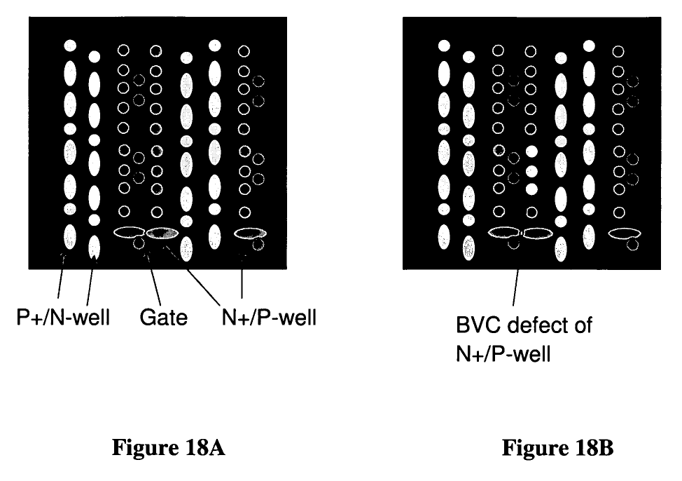

The present invention can also be applied to EBI of semiconductor devices such as static random access memory (SRAM) arrays. By using the gray level of plugs that connect to P+/N-well as the reference pattern, the degree of leakage of the BVC defects on plugs that connect to N+/P-well or on the gates of the WCMP layer, the test pattern, can be determined. FIG. 18A illustrates a SEM image of a normal SRAM. FIG. 18B illustrates a SEM image of a SRAM with N+/P-well leakage.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for determining abnormal characteristics in integrated circuit manufacturing process, comprising:
obtaining a charged particle microscope image of a sample, wherein said sample including a reference pattern and a test pattern;
measuring gray levels of said reference pattern and said test pattern;
calculating a standard deviation from a distribution of said gray levels of said reference pattern measured; and
determining the abnormal characteristics of said test pattern based on said gray levels measured and said standard deviation.

2. The method for determining abnormal characteristics of claim 1, wherein said gray levels are measured by using a charged particle beam.

3. The method for determining abnormal characteristics of claim 2, wherein said charged particle beam comprises an e-beam.

4. The method for determining abnormal characteristics of claim 1, wherein said abnormal characteristics indicate the level of leakage to the ground of said test pattern.

5. The method for determining abnormal characteristics of claim 1, wherein said determining the abnormal characteristics step comprising:
calculating an average gray level from said gray levels of said reference pattern measured;
calculating a factor based on said average gray level, said gray level of said test pattern and said standard deviation;
predetermining at least one characteristic value; and
comparing said factor to said characteristic value.

6. The method for determining abnormal characteristics of claim 5, wherein said factor is calculated by taking the difference of said average gray level and said gray level of said test patterns then divide the difference by said standard deviation.

7. The method for determining abnormal characteristics of claim 5, wherein said characteristic value is predetermined by an electrical test that using probes with different voltages to contact different parts of the sample and measure the leakage current.

8. The method for determining abnormal characteristics of claim 1, wherein the reference pattern comprises at least one integrated circuit device having source/drain-to-substrate short.

9. The method for determining abnormal characteristics of claim 1, wherein the reference pattern comprises at least one integrated circuit device having source/drain-to-well short.

10. The method for determining abnormal characteristics of claim 1, wherein the test pattern comprises at least one integrated circuit device to be tested.

11. The method for determining abnormal characteristics of claim 10, wherein said at least one integrated circuit device comprises a bright voltage contrast defect.

12. The method for determining abnormal characteristics of claim 1, wherein said charged particle microscope image is obtained after a silicide formation.

13. The method for determining abnormal characteristics of claim 1, wherein said charged particle microscope image is obtained after tungsten chemical mechanical polishing.

14. The method for determining abnormal characteristics of claim 1, wherein said sample comprises a static random access memory array.

15. The method for determining abnormal characteristics of claim 14, wherein said reference pattern comprises P+/N well.

16. The method for determining abnormal characteristics of claim 14, wherein said test pattern comprises N+/P well.

17. The method for determining abnormal characteristics of claim 14, wherein said test pattern comprises a gate at tungsten chemical mechanical polish layer.

18. A computer readable medium encoded with a computer program for determining abnormal characteristics in integrated circuit manufacturing process, comprising:
obtaining a charged particle microscope image of a sample, wherein said sample including a reference pattern and a test pattern;
measuring gray levels of said reference pattern and said test pattern;
calculating a standard deviation from a distribution of said gray levels of said reference pattern measured; and
determining the abnormal characteristics of said test pattern based on said gray levels measured and said standard deviation.

19. The computer readable medium for determining abnormal characteristics of claim 18, wherein said gray levels are measured by using a charged particle beam.

20. The computer readable medium for determining abnormal characteristics of claim 19, wherein said charged particle beam comprises an e-beam.

21. The computer readable medium for determining abnormal characteristics of claim 18, wherein said abnormal characteristics indicate the level of leakage to the ground of said test pattern.

22. The computer readable medium for determining abnormal characteristics of claim 18, wherein said determining the abnormal characteristics step comprising:
calculating an average gray level from said gray levels of said reference pattern measured;
calculating a factor based on said average gray level, said gray level of said test pattern and said standard deviation;
predetermining at least one characteristic value; and
comparing said factor to said characteristic value.

23. The computer readable medium for determining abnormal characteristics of claim 22, wherein said factor is calculated by taking the difference of said average gray level and said gray level of said test pattern then divide the difference by said standard deviation.

24. The computer readable medium for determining abnormal characteristics of claim 22, wherein said characteristic value is predetermined by an electrical test that using probes with different voltages to contact different parts of the sample and measure the leakage current.

25. The computer readable medium for determining abnormal characteristics of claim 18, wherein the reference pattern comprises at least one integrated circuit device having source/drain-to-substrate short.

26. The computer readable medium for determining abnormal characteristics of claim 18, wherein the reference pattern comprises at least one integrated circuit device having source/drain-to-well short.

27. The computer readable medium for determining abnormal characteristics of claim 18, wherein the test pattern comprises at least one integrated circuit device to be tested.

28. The computer readable medium for determining abnormal characteristics of claim 27, wherein said at least one integrated circuit device comprises a bright voltage contrast defect.

29. The computer readable medium for determining abnormal characteristics of claim 18, wherein said charged particle microscope image is obtained after a silicide formation.

30. The computer readable medium for determining abnormal characteristics of claim 18, wherein said charged particle microscope image is obtained after tungsten chemical mechanical polishing.

31. The computer readable medium for determining abnormal characteristics of claim 18, wherein said sample comprises a static random access memory array.

32. The computer readable medium for determining abnormal characteristics of claim 31, wherein said reference pattern comprises P+/N well.

33. The computer readable medium for determining abnormal characteristics of claim 31, wherein said test pattern comprises N+/P well.

34. The computer readable medium for determining abnormal characteristics of claim 31, wherein said test pattern comprises a gate at tungsten chemical mechanical polish layer.
